(19) United States
(12) Patent Application Publication
(10) Pub. No.: US 2003/0147789 A1
(43) Pub. Date: Aug. 7, 2003

(54) System for detoxification of toxic organic chlorinated compound and method of recycling the detoxified waste

(75) Inventors: Akira Adachi, Yokohama-shi (JP); Tomohiro Imai, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/359,241

(22) Filed: Feb. 6, 2003

(30) Foreign Application Priority Data
Feb. 7, 2002 (JP) 2002-031325

(51) Int. Cl. B01J 8/00

(52) U.S. Cl. 422/223; 588/213; 422/189

(57) ABSTRACT

The present invention provides a system for detoxification of a toxic organic chlorinated compound, the system comprising: a detoxification process unit for decomposing the toxic organic chlorinated compound into a harmless organic compound by adding an additive including hydrogen donor, alkaline substance and precious metal catalyst to the toxic organic chlorinated compound stored in a container or included in a waste device, thereby to obtain harmless products; a reproducing process unit for regenerating the products obtained by the detoxification process unit thereby to provide regenerated products; and a recycle line for supplying the products obtained from the detoxification process unit to the reproducing process unit, and for supplying the regenerated products to the detoxification process unit so that the regenerated products are reused as a material for decomposing the toxic organic chlorinated compound.

### BACKGROUND OF THE INVENTION

1. Field of the Invention

The present invention relates to a system for detoxification of a toxic organic chlorinated compound and a method of recycling the detoxified products and waste.

2. Description of the Related Art

Conventionally, as a final disposing method of products generated at a waste disposal, a landfill (reclamation) process or an incineration (burning) process have been widely adopted. Further, if the products generated at the waste disposal can be detoxified, the detoxified products have been discharged to rivers and oceans or the gaseous products have been exhausted to atmosphere. Furthermore, as to a metal waste generated at a time of scrapping a disposal unit and waste device and organic substances such as waste cloth, plastic bag or the like, a part of them have been recycled while most of them have been subjected to the landfill process.

When the products generated at the waste disposal and waste members generated after scrapping the disposal unit and waste device are subjected to the landfill operation or the incineration process as described above, a disposable capacity of the reclaimed ground will be decreased in a short time of period, and a great potential exists to lead to soil contamination, river pollution or marine contamination. Further, when an exhaust gas generated by the incineration process is discharged to atmosphere, there may be a fear of causing an atmospheric contamination.

Accordingly, it is required to recycle the products generated by the waste disposal as much as possible, and to suppress a generation amount of the waste products as small as possible. Therefore, it becomes important to realize a recycling-oriented society creating a recycling loop or a recycling environment constituted by process and transportation of the toxic organic chlorinated compound, and a reuse of the waste products. In order to realize the recycling-oriented society, it is required to establish stronger ties among local residents, autonomous communities and business enterprises.

### SUMMARY OF THE INVENTION

The present invention has been made to cope with the problems and demands mentioned above, and an object of the present invention is to provide a system for detoxification of a toxic organic chlorinated compound, which can effectively reuse products generated at a time of detoxification process of the toxic organic chlorinated compound and a waste generated at a time of scrapping the detoxification unit and waste devices, and to provide a method of recycling the processed products and detoxified waste obtained by the detoxification process.

To achieve the above object, in one aspect of the present invention, there is provided a system for detoxification of a toxic organic chlorinated compound, the system comprising:

a detoxification process unit for decomposing the toxic organic chlorinated compound into a harmless organic compound by adding an additive including hydrogen donor, alkaline substance and precious metal catalyst to the toxic organic chlorinated compound stored in a container or included in a device, thereby to obtain harmless products;

a reproducing process unit for regenerating the products obtained by the detoxification process unit thereby to provide regenerated products; and

a recycle line for supplying the products obtained from the detoxification process unit to the reproducing process unit, and for supplying the regenerated products to the detoxification process unit so that the regenerated products is reused as a material for decomposing the toxic organic chlorinated compound.

In another aspect of the present invention, there is provided a system for detoxification of a toxic organic chlorinated compound according to the aforementioned system, wherein the reproducing process unit comprises a distillation unit for distilling a processed oil, which is obtained by the detoxification process at the detoxification process unit, thereby to recover a non-reacted hydrogen donor; and

wherein the recycle line supplies the recovered non-reacted hydrogen donor to the detoxification process unit so that the recovered non-reacted hydrogen donor is reused as a material for decomposing the toxic organic chlorinated compound.

In further aspect of the present invention, there is provided a system for detoxification of a toxic organic chlorinated compound according to the aforementioned system, wherein the reproducing process unit comprises an alkaline substance manufacturing unit, to which a saturated salt solution containing salt generated at the detoxification process unit is supplied, for regenerating the salt into alkaline substance, and

wherein the recycle line supplies the regenerated alkaline substance to the detoxification process unit so that the regenerated alkaline substance is reused as a material for decomposing the toxic organic chlorinated compound.

In still further aspect of the present invention, there is provided a system for detoxification of a toxic organic chlorinated compound according to aforementioned system, wherein the reproducing process unit comprises a regeneration unit, to which the precious metal catalyst used at the detoxification process unit is supplied, for sintering and regenerating the used precious metal catalyst, thereby to produce a regenerated precious metal catalyst; and

wherein the recycle line supplies the regenerated precious metal catalyst to the detoxification process unit.

In still further aspect of the present invention, there is provided a system for detoxification of a toxic organic chlorinated compound according to the aforementioned system, wherein the reproducing process unit comprises at least two units of:

a distillation unit for distilling a processed oil, which is obtained by the detoxification process at the detoxification process unit, thereby to recover a non-reacted hydrogen donor as a processed products;

an alkaline substance manufacturing unit, to which a saturated salt solution containing salt generated at the detoxification process unit is supplied, for regenerating the salt into the alkaline substance as reproduced products; and

a regeneration unit, to which the precious metal catalyst used at the detoxification process unit is supplied, for sintering and regenerating the used precious metal catalyst, thereby to produce a regenerated precious metal catalyst as regenerated products;

wherein the recycle line supplies the recovered non-reacted hydrogen donor, the regenerated precious metal catalyst and the regenerated alkaline substance to the detoxification process unit, respectively.

In still further aspect of the present invention, there is provided a system for detoxification of a toxic organic chlorinated compound according to the aforementioned system, wherein the detoxification process unit further comprises:

a take-out unit for boring a hole to a device and taking out the toxic organic chlorinated compound contained in the device, through the hole;

a first shredding unit for shredding an insulation substance and metal member contained in the device;

a first scrub unit for scrubbing the crushed insulation substance and metal member;

a melting unit for melting the scrubbed metal member to provide a metal raw material which is to be reused;

a second shredding unit for shredding at least one organic substance selected from the group consisting of waste cloth, plastic bag, paper and timber used in a decomposing process of the toxic organic chlorinated compound; and

a second scrub unit for scrubbing the crushed organic substance to provide a scrubbed organic substance,

wherein the recycle line supplies the scrubbed organic substance to the reproducing process unit and the reproducing process unit performs a reduction process to the scrubbed organic substance thereby to produce a reducer to be reused.

In still further aspect of the present invention, there is provided a system for detoxification of a toxic organic chlorinated compound, the system comprising:

a detoxification process unit for decomposing the toxic organic chlorinated compound into a harmless organic compound by adding an additive including hydrogen donor, alkaline substance and precious metal catalyst to the toxic organic chlorinated compound stored in a container or included in a device, thereby to obtain a processed products;

a distillation unit, which is installed in the detoxification process unit, for distilling a processed oil obtained by the detoxification process at the detoxification process unit, thereby to recover a hydrogen donor; and

a recycle line for supplying the hydrogen donor to the detoxification process unit so that the hydrogen donor is reused in the detoxification process for the toxic organic chlorinated compound, and for supplying the processed oil from which the hydrogen donor is removed or a fractionally separated oil to an user so that the oil is reused as a material for chemical industrial products.

In still further aspect of the present invention, there is provided a system for detoxification of a toxic organic chlorinated compound, the system comprising:

a detoxification process unit for decomposing the toxic organic chlorinated compound into a harmless organic compound by adding an additive including hydrogen donor, alkaline substance and precious metal catalyst to the toxic organic chlorinated compound stored in a container or included in a device, thereby to obtain processed products;

a distillation unit, which is installed in the detoxification process unit, for distilling a processed oil obtained by the detoxification process at the detoxification process unit, thereby to recover a hydrogen donor;

an incineration unit for incinerating the processed oil from which the hydrogen donor is removed, thereby to generate exhaust heat; and

a recycle line for supplying the hydrogen donor separated and recovered at the distillation unit to the detoxification process unit so that the hydrogen donor is reused in the detoxification process for treating the toxic organic chlorinated compound, and for supplying the exhaust heat generated at the incineration unit to an user.

In still further aspect of the present invention, there is provided a system for detoxification of a toxic organic chlorinated compound according to the aforementioned system, wherein the reproducing process unit further comprises: an alkaline substance manufacturing unit, to which a saturated salt solution containing salt generated at the detoxification process unit is supplied, for regenerating the salt into the alkaline substance,

wherein the recycle line supplies the regenerated alkaline substance to the detoxification process unit, respectively.

In still further aspect of the present invention, there is provided a system for detoxification of a toxic organic chlorinated compound according to the aforementioned system, wherein the detoxification process unit further comprises:

a take-out unit for boring a hole to the device and for taking out the toxic organic chlorinated compound contained in the device through the hole;

a first shredding unit for shredding an insulating material and a metal member contained in the device;

a first scrubbing unit for scrubbing the crushed insulating material and the metal member;

a melting unit for melting the scrubbed metal member to provide a metal raw material which is to be reused;

a second shredding unit for shredding at least one organic substance selected from the group consisting of waste cloth, plastic bag, paper and timber used in a decomposing process of the toxic organic chlorinated compound; and

a second scrub unit for scrubbing the crushed organic substance to provide a scrubbed organic substance,

wherein the recycle line supplies the scrubbed organic substance to the reproducing process unit and the reproducing process unit performs a reduction process to the scrubbed organic substance thereby to produce a reducer which is reused through the recycle line.

In still further aspect of the present invention, there is provided a system for detoxification of a toxic organic chlorinated compound according to the aforementioned system, wherein the detoxification process unit comprises a plurality of detoxification process elements installed at different sites, and the reproducing process unit comprises a plurality of reproducing process elements for reproducing products processed by each detoxification process elements, the number of the installed reproducing process elements being less than the number of the installed detoxification process elements,

wherein the products reproduced by the plurality of the detoxification process elements are concentrately supplied to the reproducing process elements so that the reproducing process elements process the products thereby to provide processed products, and

wherein the recycle line supplies the processed products obtained from the reproducing process elements to the detoxification process elements so that the processed products are reused as a material for decomposing the toxic organic chlorinated compound.

In still further aspect of the present invention, there is provided a system for detoxification of a toxic organic chlorinated compound according to the aforementioned system, wherein the detoxification process unit comprises a plurality of detoxification process elements installed at different sites, and the reproducing process unit comprises a plurality of distillation elements for distilling a processed oil, which is obtained by the detoxification process at the detoxification process elements, thereby to recover a non-reacted hydrogen donor; the number of the installed distillation elements being less than the number of the installed detoxification process elements and

wherein the processed oil obtained by the detoxification process at the detoxification process elements is concentrately supplied to the distillation elements, and the recycle line supplies the recovered non-reacted hydrogen donor to the detoxification process elements so that the recovered non-reacted hydrogen donor is reused as a material for decomposing the toxic organic chlorinated compound.

In still further aspect of the present invention, there is provided a system for detoxification of a toxic organic chlorinated compound according to the aforementioned system, wherein the detoxification process unit comprises a plurality of detoxification process elements installed at different sites, and the reproducing process unit comprises a plurality of alkaline substance manufacturing elements, to which a saturated salt solution containing salt generated at the detoxification process elements is supplied, for regenerating the salt into the alkaline substance, the number of the installed alkaline substance manufacturing elements being less than the number of the installed detoxification process elements and

wherein the saturated salt solution containing salt generated at the detoxification process elements is concentrately supplied to the alkaline substance manufacturing elements, and the recycle line supplies the regenerated alkaline substance to the detoxification process elements so that the regenerated alkaline substance is reused as a material for decomposing the toxic organic chlorinated compound.

In still further aspect of the present invention, there is provided a system for detoxification of a toxic organic chlorinated compound according to the aforementioned system, wherein the detoxification process unit comprises a plurality of detoxification process elements installed at different sites, and the reproducing process unit comprises a plurality of regeneration elements, to which precious metal catalyst used at the detoxification process elements is supplied, for sintering and regenerating the used precious metal catalyst, thereby to produce a regenerated precious metal catalyst, the number of the installed regeneration elements being less than the number of the installed detoxification process elements and

wherein the used precious metal catalyst used at the detoxification process elements is concentrately supplied to the regeneration elements, and the recycle line supplies the regenerated precious metal catalyst to the detoxification process elements.

In still further aspect of the present invention, there is provided a system for detoxification of a toxic organic chlorinated compound according to the aforementioned system, wherein the reproducing process unit further comprises at least two groups of elements consisting of:

a plurality of distillation elements for distilling a processed oil, which is obtained by the detoxification process at the detoxification process elements, thereby to recover a non-reacted hydrogen donor;

a plurality of alkaline substance manufacturing elements, to which a saturated salt solution containing salt generated at the detoxification process elements is supplied, for regenerating the salt into the alkaline substance, and

a plurality of regeneration elements, to which precious metal catalyst used at the detoxification process elements is supplied, for sintering and regenerating the used precious metal catalyst, thereby to produce a regenerated precious metal catalyst, each of the number of the installed distillation elements, the installed alkaline substance manufacturing elements and the installed regeneration elements being less than the number of the installed detoxification process elements and

wherein the saturated salt solution containing salt generated at the detoxification process elements is concentrately supplied to the alkaline substance manufacturing elements, and the recycle line supplies the regenerated alkaline substance to the detoxification process elements so that the regenerated alkaline substance is reused as a material for decomposing the toxic organic chlorinated compound.

In still further aspect of the present invention, there is provided a method of recycling a detoxified waste comprising the steps of:

adding an additive including hydrogen donor, alkaline substance and precious metal catalyst to a toxic organic chlorinated compound;

decomposing the toxic organic chlorinated compound into a harmless organic compound thereby to provide products; and

recycling the products by utilizing at least one processing method selected from the group consisting of:

(1) a processing method in which a non-reacted hydrogen donor is recovered from a processed oil as the products obtained from the decomposing process, and the non-reacted hydrogen donor is reused as a material for decomposing the toxic organic chlorinated compound;

(2) a processing method in which a waste oil produced by removing hydrogen donor from the processed oil obtained from the decomposing process is reused as a material of chemical industrial products; or the waste oil or an oil produced by removing valuable resource from the waste oil is incinerated and the exhausted heat is utilized as a heat resource;

(3) a processing method in which a precious metal catalyst used at the decomposing process is regenerated and the regenerated precious metal catalyst is reused as a material for decomposing the toxic organic chlorinated compound; and

(4) a processing method in which a salt obtained from the decomposing process is regenerated into an alkaline substance and the regenerated alkaline substance is reused as a material for decomposing the toxic organic chlorinated compound.

In still further aspect of the present invention, there is provided a method of recycling a detoxified waste comprising the steps of:

adding an additive including hydrogen donor, alkaline substance and precious metal catalyst to a toxic organic chlorinated compound stored in a container or included in a device;

decomposing the toxic organic chlorinated compound into a harmless organic compound;

detoxifying at least one organic substance selected from the group consisting of waste cloth, plastic bag, paper and timber used in the decomposing process of the toxic organic chlorinated compound;

applying a reduction process to the detoxified organic substance thereby to produce a reducer, and utilizing the reducer;

detoxifying a metal member generated at a time of scrapping the container or the device, and melting and regenerating the detoxified metal member, thereby to utilize the regenerated metal member as a raw metal material.

### BRIEF DESCRIPTION OF THE DRAWINGS

FIG. 1 is a schematic view for explaining one embodiment of the system for detoxification of a toxic organic chlorinated compound and a method of recycling the detoxified products and waste according to the present invention.

FIG. 2 is a schematic view for explaining another embodiment of the system for detoxification of a toxic organic chlorinated compound and a method of recycling the detoxified products and waste according to the present invention.

### DESCRIPTION OF THE PREFERRED EMBODIMENTS

Embodiments of the present invention will be described below with reference to the drawings.

As the toxic organic chlorinated compound to be handled and processed in the system for detoxification of the toxic organic chlorinated compound and a method of recycling the detoxified products and waste according to the present invention, any toxic organic chlorinated compound can be applied as far as the toxic organic chlorinated compound can be decomposed into a harmless organic compound by being added with an additive including hydrogen donor, alkaline substance or precious metal catalyst. For example, the example of the toxic organic chlorinated compound may include: polychlorinated biphenyl (PCB) or the like.

Further, as the toxic organic chlorinated compound to be processed by the system or the recycling method of the present invention, a toxic organic chlorinated compound contained in the device or a member can be also applied other than the toxic organic chlorinated compound which is taken-out in advance from the device or the like and stored in a container. For example, the toxic organic chlorinated compound contained in electric machinery and apparatus such as capacitor, transformer or the like can be also effectively subjected to the detoxification process.

In the process for detoxification of the toxic organic chlorinated compound, the process conditions such as addition amount of the hydrogen donor, alkaline substance, precious metal catalyst or the like, processing time, temperature, pressure or the like are appropriately determined so that the toxic organic chlorinated compound can be decomposed to obtain a level lower than a criterion level.

In the system for detoxification of the toxic organic chlorinated compound according to the present invention, the system is provided with: a recycle line capable of recycling the detoxified products obtained by decomposing the toxic organic chlorinated compound in the detoxification unit; and another recycling line capable of reusing the regenerated products as a material for decomposing the toxic organic chlorinated compound, the regenerated products being obtained by performing a regeneration process at the reproduction unit.

Further, in the system for detoxification of the toxic organic chlorinated compound, the system may comprises a recycle line for recycling (reusing) the detoxified organic substance obtained by detoxification of the organic substance such as waste cloth, plastic bag, paper, timber or the like in the detoxification unit. Furthermore, the system may comprises another recycle line for recycling (reusing) the detoxified waste such as metal container after taking-out the toxic organic chlorinated compound and metal member or the like generated by scrapping the devices.

These recycle lines are constituted by a transfer means corresponding to an installation site and products of the detoxification unit for detoxification of the organic compound or the waste. For example, the recycle lines are constituted by providing transfer lines such as piping, conveyor, vehicle, tank lorry, dump track or the like.

According to this system for detoxification of the toxic organic chlorinated compound, the method of recycling the detoxified products (reproduced products), the method of recycling the detoxified waste, the processed products (reproduced products) obtained by the detoxification of the toxic organic chlorinated compound, the organic substance used in the detoxification process and the waste obtained from the detoxification process are traded as valuable resource, then effectively utilized and reused.

Hereunder, embodiments of the system for detoxification of the toxic organic chlorinated compound, the method of recycling the detoxified products (reproduced products), the method of recycling the detoxified waste will be explained with reference to the accompanying drawings.

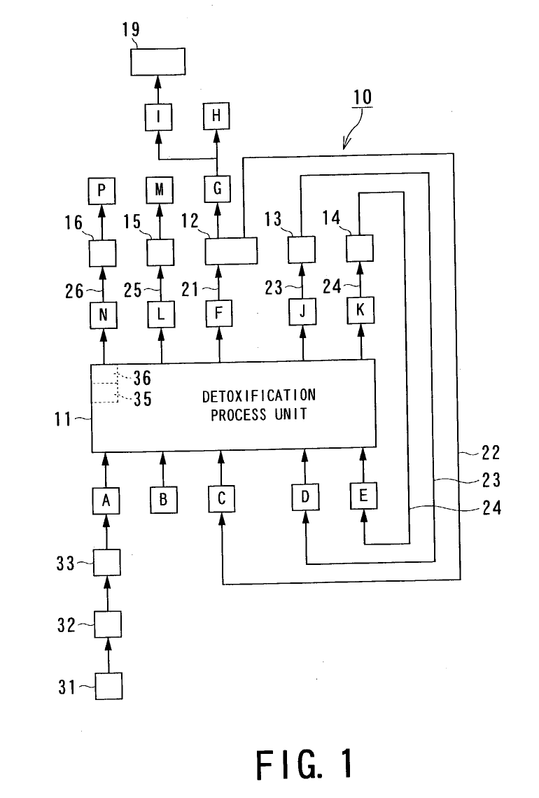

FIG. 1 is a schematic view showing one embodiment of the system for detoxification of the toxic organic chlorinated compound. The method of recycling the detoxified products and the detoxified waste of this invention can be performed by utilizing the above detoxification process system.

In FIG. 1, the detoxification process system 10 for the toxic organic chlorinated compound comprises a detoxification process unit 11 (having no distillation unit for recovering a hydrogen donor C) for detoxification of the toxic organic chlorinated compound. The detoxification process unit 11 is provided with various reproducing process units such as: a distillation unit 12 owned by a distiller; an electrolysis unit (alkaline substance manufacturing unit) 13 owned by an alkaline-substance manufacturer; a sintering (regenerating) unit 14 owned by a catalyst manufacturer; a melting unit 15 owned by a metal maker; a thermal decomposing unit 16 owned by a processor.

Further, the detoxification process system 10 further comprises: recycle lines 21, 22, 23 and 24 for supplying the detoxified products from the detoxification process unit 11 to the reproducing process units 12, 13, 14 and 15, or for supplying the regenerated products processed by the reproducing process units 12-15 to the detoxification process unit 11; and recycle lines 25 and 26 for supplying the detoxified waste from the detoxification process unit 11 to the reproducing process units 15 and 16.

Furthermore, the detoxification process system 10 further comprises: a take-out unit 31 for taking out the toxic organic chlorinated compound from various waste devices; a shredding unit 32 for shredding an insulation substance and metal member contained in the devices; a scrub unit 33 for scrubbing the crushed insulation substance and metal member. The above take-out unit 31, the shredding unit 32 and the scrub unit 33 are installed as pre-processing units of the detoxification process unit 11.

The toxic organic chlorinated compound B taken-out from the devices or the like and stored in a container vessel such as a metal drum or the like is directly supplied from the container vessel to the detoxification process unit 11 at which the compound B is subjected to the detoxification process.

On the other hand, the toxic organic chlorinated compound A contained in various electric machineries and apparatuses such as capacitor, transformer or the like is taken-out from the devices by means of the take-out unit 31. Thereafter, the taken-out compound A is supplied to the detoxification process unit 11.

For example, the take-out unit 31 bores a hole onto a device body containing the toxic organic chlorinated compound A. Then, the toxic organic chlorinated compound A in a form of liquid contained in the devices is taken out through the hole, and poured into the container vessel. Thereafter, the toxic organic chlorinated compound A is supplied to the detoxification process unit 11.

Even after the toxic organic chlorinated compound A is taken out from the devices, not so small amount of the toxic organic chlorinated compound A remains so as to adhere to an internal member of the devices. Therefore, it is required to scrap and disassemble the devices, so that the metal members constituting the devices, insulating materials contained in the devices, and other constitutional members are categorized for each materiality thereof. The categorized materials are then crushed by means of the shredding unit 32, and the crushed materials are supplied to the scrubbing unit 33. The scrubbing unit 33 scrubs the crushed material by using a solvent.

A metal member L scrubbed by the scrubbing unit 33 is supplied to the melting unit 15 owned by a metal maker through the recycle line 25, followed by being molten so as to be regenerated into a raw metal material M. The regenerated raw metal material M is served to be reused in various industrial fields.

The solvent, which was used in the scrubbing process at the scrubbing unit 33 and containing the toxic organic chlorinated compound A, is introduced to the detoxification process unit 11 in such a manner that the solvent together with the toxic organic chlorinated compound A taken out from the electric devices are introduced to the detoxification process unit 11, or the solvent is separately introduced to the detoxification process unit 11 independent from the toxic organic chlorinated compound A.

In FIG. 1, the used solvent discharged from the scrubbing unit 33 is introduced to the detoxification process unit 11 by being combined with the toxic organic chlorinated compound A. As occasion demands, the solvent containing the toxic organic chlorinated compound A is separated from the toxic organic chlorinated compound A in the detoxification process unit 11. The separated solvent is reused as the solvent for scrubbing the waste materials.

The toxic organic chlorinated compounds A and B introduced into the detoxification process unit 11 are subjected to a decomposing process at the detoxification process unit 11 so as to attain a toxic component level lower than a criterion value. The decomposing process (detoxification process) for the toxic organic chlorinated compounds A and B is performed by adding the hydrogen donor C, alkaline substance D, precious metal catalyst E to the toxic organic chlorinated compounds A and B. The resultant mixed solution is changed after the decomposing process into processed oil containing products generated by the decomposing process.

The organic substances such as waste cloth, plastic bag, paper and timber, which had been generated and used in the decomposing process for decomposing the toxic organic chlorinated compound or removing process for removing the toxic organic chlorinated compound from the devices, are crushed by means of the shredding unit 32 or the shredding unit 35 installed in the detoxification process unit 11. Thereafter, the crushed materials are scrubbed by means of the scrubbing unit 33 or the scrubbing unit 36 installed in the detoxification process unit 11 whereby the toxic organic chlorinated compound A is scrubbed and removed.

The organic substances N detoxified by the scrubbing operation at the scrubbing unit 33 or 36 are supplied through the recycle line 26 to a thermal decomposition unit 16 owned by a organic substance dealer. The organic substances N are subjected to thermal decomposition process so as to be regenerated into a reducer P. The reducer P is reused as a reducing material for a metal purification process.

On the other hand, the processed oil F, which is a solution obtained by the decomposing process performed at the detoxification process unit 11, is supplied through the recycle line 21 to the distillation unit 12 owned by a hydrogen donor maker. The processed oil F is distillated at the distillation unit 12 so as to be separated into a non-reacted hydrogen donor C included in the processed oil F and waste oil G mainly composed of decomposed products H. Among these products, the hydrogen donor C is re-circulated through the recycle line 22 and supplied again to the detoxification process unit 11 and reused.

Further, the waste oil G is further decomposed to be separated into the processed products H and the fuel (heat source) I. The products H obtained by decomposing the waste oil G are further separated and recovered, and the recovered products are regenerated and effectively reused. Furthermore, the waste oil G per se or an oil obtained by removing an usable material (processed products H) from the waste oil G is used as a fuel I. When the fuel I is incinerated to exhaust heat, the exhausted heat can be also effectively utilized as a heat source.

The salt J produced by the detoxification process at the detoxification process unit 11 is supplied as a saturated solution of the salt through the recycle line 23 to an electrolysis unit 13 owned by alkaline-substance maker. Then, the saturated solution of the salt is electrolyzed to regenerate the salt into alkaline substance D. The regenerated alkaline substance D is re-circulated through the recycle line 23 and supplied to the detoxification process unit 11 at which the regenerated alkaline substance D is reused as a material for decomposing the toxic organic chlorinated compounds.

The used precious metal catalyst K of which activity is lowered due to the operation (use) in the detoxification process unit 11 is supplied through the recycle line 24 to a sintering (regenerating) unit 14 owned by a catalyst maker, and subjected to a sintering and regenerating process. The regenerated precious metal catalyst K is re-circulated through the recycle line 24 and supplied again to the detoxification process unit 11. The regenerated precious metal catalyst K is reused as a catalyst for decomposing the toxic organic chlorinated compounds.

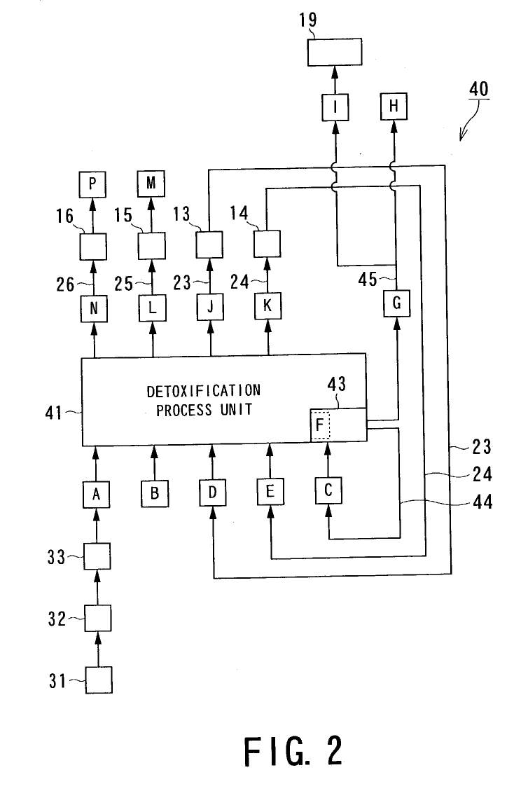

FIG. 2 is a schematic view showing another embodiment of the system for detoxification of the toxic organic chlorinated compound. Utilizing the above detoxification process system can also perform the method of recycling the detoxified products and waste according to the present invention.

The detoxification process system 40 for detoxification of the toxic organic chlorinated compound shown in FIG. 2 comprises a detoxification process unit 41 for detoxification of the toxic organic chlorinated compound. The detoxification process unit 41 further comprises a distillation unit 43 for recovering the hydrogen donor C.

The detoxification process unit 41 is further provided with: a electrolysis unit (alkaline substance manufacturing unit) 13 owned by an alkaline substance maker; a sintering (regenerating) unit 14 owned by a catalyst maker, and a melting unit 15 owned by metal maker.

Further, the detoxification process system 40 further comprises: a thermal decomposition unit 16 owned by a processor; recycle lines 23, 24 and 44 for supplying the detoxified products from the detoxification process unit 41 to the reproducing process units 13, 14, 15 and 16, or for supplying the regenerated products processed by the reproducing process units to the detoxification process unit 41; and recycle lines 25 and 26 for supplying the detoxified waste from the detoxification process unit 41 to the reproducing process units 15 and 16.

Furthermore, the detoxification process system 40 further comprises: a take-out unit 31; a shredding unit 32; and a scrub unit 33. The above take-out unit 31, the shredding unit 32 and the scrub unit 33 are installed as pre-processing units of the detoxification process unit 41.

The above detoxification process system 40 is substantially the same as the detoxification process system 10 shown as a first embodiment. However, the system 40 is different from the system 10 in a point that the detoxification process system 40 comprises a distillation unit 43 for recovering the hydrogen donor C and the distillation unit 43 is installed within the detoxification process system 40.

In the above detoxification process system 40, the detoxification process unit 41 comprises a distillation unit 43 for recovering the hydrogen donor C. The distillation unit 43 distills a processed oil F, which is a solution obtained by the decomposing process, and the distillation unit 43 separates the processed oil F into non-reacted hydrogen donor C and a waste oil G mainly composed of decomposed products H. The separated hydrogen donor C is supplied through a recovery line 44 as the recycle line to the detoxification process unit 41 and reused as a material for detoxification of the toxic organic chlorinated compound.

On the other hand, the decomposed products H contained in the waste oil G is separately recovered, and the resultant products are regenerated so that the regenerated products is effectively reused as a material for forming chemical industrial products. Therefore, the waste oil G or the separated oil can be supplied through the recycle line 45 to a user. Furthermore, the waste oil G may be supplied to an incineration unit owned by a user, and used as a fuel I. When the fuel I is incinerated to exhaust heat, the exhausted heat can be also effectively utilized as a heat source.

In a case where the system for detoxification of the toxic organic chlorinated compound is installed on two or more of different installation sites, the detoxification process system 10 (or 40) may be constituted by providing the detoxification process unit 11 (or 41) and the reproducing process unit for reproducing the products obtained at the detoxification process unit for each of the different installation sites.

Further, the detoxification process system 10 (or 40) may be also constituted in such a manner that the detoxification process unit (element) 11 (or 41) is respectively installed on each of two or more of different installation sites, while the reproducing process unit (element) is not installed for each installation sites but only one reproducing process unit is installed or a plurality (number is less than that of the detoxification process units (elements)) of the reproducing process units (elements) are installed on pertinent sites.

More concretely, in a case where reduced number of the reproducing process units are installed at a number less than that of the detoxification process units (elements)), the products generated at the plurality of the detoxification process units (elements)) are concentrately supplied to a particular reproducing process unit (element) for decomposing the products thereby to provide the regenerated products. The detoxification process system 10 (or 40) also comprises a recycle line for supplying the regenerated products to the plurality of the detoxification process units (elements)). The regenerated products are reused as a material for detoxification of the toxic organic chlorinated compound.

For example, a recycle line having the following function may be adopted to the system:

(1) a recycle line for concentrately supplying the processed oil obtained by the detoxification process at the plurality of the detoxification process elements 11 (provided with no distillation unit for recovering the hydrogen donor) installed on different installation sites, to the distillation units 12, the number of the distillation units being less than that of the detoxification process elements 11, the distillation unit 12 distils the processed oil to recover the non-reacted hydrogen donor, the recycle line also supplies the recovered hydrogen donor to the plurality of the detoxification process elements 11;

(2) a recycle line for concentrately supplying the salt in a form of saturated salt solution generated at the plurality of the detoxification process elements 11, to the alkaline substance manufacturing units, the number of the alkaline substance manufacturing units being less than that of the detoxification process elements 11, the alkaline substance manufacturing units regenerate the processed oil to provide the regenerated alkaline substance, the recycle line also supplies the regenerated alkaline substance to the plurality of the detoxification process elements 11;

(3) a recycle line for concentrately supplying the precious metal catalyst used at the plurality of the detoxification process elements 11, to the regenerating units, the number of the regenerating units being less than that of the detoxification process elements 11, the regenerating units regenerate the used precious metal catalyst to provide the regenerated precious metal catalyst, the recycle line also supplies the regenerated precious metal catalyst to the plurality of the detoxification process elements 11; and

(4) recycle lines constituted by combining at least two of the above recycle lines of (1)-(3).

In a case where the plurality of the detoxification process elements 41 installed on different installation sites comprise the distillation unit 43 for recovering the hydrogen donor C, one or more of the recycle line selected from the aforementioned recycle lines of (1) to (3).

Further, in a case where the plurality of the detoxification process elements installed on different installation sites comprise: a detoxification process element 11 having no distillation unit for recovering the hydrogen donor C; and the detoxification process element 41 having the distillation unit for recovering the hydrogen donor C, at least one of the recycle line is selected from the aforementioned recycle lines of (2) to (3). Furthermore, in a case where a plurality of the detoxification process elements 11 are installed, the recycle line of aforementioned (1) can be also adopted.

As described above, when the plurality of the reproducing process units are installed at an installation number less than that of the detoxification process units and the reproducing process units concentrately handle the products generated from the plurality of the detoxification process units, it becomes also possible to reduce a processing cost of the regenerated products.

In addition, it is possible to realize a detoxification process system for detoxification of the toxic organic chlorinated compound, which can meet the requirements and can satisfy the local conditions such as process capacity of each of the detoxification process units, possibility of securing the reproducing process unit, process capacity of the reproducing process unit or the like.

According to the method of recycling the detoxified products of the present invention, additives such as hydrogen donor, alkaline substance, precious metal catalyst are added to the toxic organic chlorinated compound, so that the toxic organic chlorinated compound can be decomposed into a harmless organic compound thereby to obtain the products. Therefore, the products obtained by the decomposing process can be effectively reused as a valuable resource. More concretely, the following processing methods of (A) to (D) can be effectively adopted.

(A) The toxic organic chlorinated compound is decomposed at the detoxification process unit 11, 41 thereby to obtain a processed oil F. The processed oil F is distilled at distillation unit 12, 43 thereby to recover non-reacted hydrogen donor C. The recovered non-reacted hydrogen donor C is regenerated and reused as a material for detoxification of the toxic organic chlorinated compound.

(B) The toxic organic chlorinated compound is decomposed at the detoxification process unit 11, 41 thereby to obtain a processed oil F. The processed oil F is distilled and separated at distillation unit 12, 43 thereby to obtain a waste oil G from which the non-reacted hydrogen donor C is removed. A usable material separated from the waste oil G is regenerated into a material H for producing chemical industrial products. In another method, when the waste oil G per se or an oil from which the usable material is removed is incinerated as fuel I, the resultant heat generation can be used as a heat resource. For example, the toxic organic chlorinated compound such as PCB or the like is decomposed thereby to separate the compound into hydrogen donor C, water and the waste oil G. As a result, compounds such as acetone, biphenyl or the like can be obtained. In addition, the separated water can be also used as a heat transfer medium for a boiler to be used for the process for decomposing the toxic organic chlorinated compound.

(C) The precious metal catalyst E used in decomposing process at the detoxification process unit 11, 41 is regenerated at a combustion equipment 19. The regenerated precious metal catalyst E can be reused as a material for decomposing the toxic organic chlorinated compound.

(D) The salt such as sodium chlorinated or the like obtained by decomposing process at the detoxification process unit 11, 41 is regenerated into alkaline substance D such as sodium hydrate or the like. The regenerated alkaline substance D is reused as a material for decomposing the toxic organic chlorinated compound.

The aforementioned processing methods of (A)-(D) including decomposing process, regenerating process and reuse operation can be performed independently. However, the processing methods of (A)-(D) can be also performed by combining two or more of the processing methods.

As shown in the processing methods of (A), (C) and (D), when the products F, J and K obtained by the decomposing process are recovered and regenerated, then reused as a material for the decomposing process, it becomes possible to reduce the cost required for the detoxification process of the toxic organic chlorinated compound.

Further, as shown in the processing method of (D), when the salt is separated and recovered from the processed oil F, the amount of the salt contained in the processed oil F can be reduced to an extremely low level. Therefore, when the waste oil per se or the waste oil G from which the usable material is removed is incinerated as shown in the processing method of (B), it becomes possible to effectively prevent toxic substances such as dioxin or the like from generating.

In the method of recycling the detoxified waste according to the present invention, the hydrogen donor C, the alkaline substance D, and the precious metal catalyst E are added to the toxic organic chlorinated compounds A, B stored in a container vessel or included in various waste devices, so that the toxic organic chlorinated compounds A, B are decomposed into harmless organic compounds. Further, the organic substances N such as waste cloth, plastic bag, paper, timber or the like used in the decomposing process can be effectively reused as a valuable resource. More concretely, the organic substances N used in the decomposing process are scrubbed and detoxified. Then, the detoxified organic substances N are subjected to a reduction process to form a reducer P. The reducer P can be utilized as coke or coke alternative.

Further, the metal members generated at a time of scrapping a device containing the toxic organic chlorinated compound A, B can be also effectively reused as a valuable resource. More concretely, the metal members L of the scrapped device are scrubbed and detoxified. The detoxified metal members L are melted and regenerated to be used as a raw metal material M.

In accordance with the system for detoxification of the toxic organic chlorinated compound of the present invention, the method of recycling the detoxified products and the detoxified waste can be performed.

Each of (i) the processed products F, J, K obtained by detoxification of the toxic organic chlorinated compounds A, B; (ii) the organic substances N used in the detoxification process; and (iii) the waste materials L such as scrapped device members can be sold to a trader. When the regenerated products obtained by processing the processed products F, J, K or the waste materials L, N are purchased, the purchased products or materials can be used for the detoxification process. Further, the regenerated products P, M, H, I can be sold and reused in other industrial fields.

By establishing the aforementioned recycling loop, an amount of the generated waste products can be effectively reduced, so that worsening of the global environment and social surroundings can be avoided. In addition, due to the aforementioned recycling loop, it becomes possible to remarkably reduce a cost required for the detoxification process, and foster many new businesses and industries.

In this connection, although the embodiments of the present invention have been explained by taking the toxic organic chlorinated compound contained in electric devices such as capacitor, transformer or the like for example, however, the present invention is not limited thereto. Namely, the present invention can be also applied to a toxic organic chlorinated compound contained in mechanical equipment such as working machine or the like, or chemical equipment. Further, the mechanical equipment itself or the chemical equipment per se can be also a target to be processed in accordance with the system or method of the present invention.

According to the present invention, there can be provided a system for detoxification of a toxic organic chlorinated compound and a method of recycling the detoxified products and waste, in which a products generated by the process for detoxification of the toxic organic chlorinated compound, members constituting a device containing the toxic organic chlorinated compound, an organic substance such as waste cloth, plastic bag, paper, timber or the like can be regenerate and effectively reused.

According to the present invention, since the amount of waste products can be reduced, there can be provided a method of recycling the detoxified products and the detoxified waste products. An environmental load of the recycling method can be reduced to be small.

Further, since the salt, particularly sodium chlorinated, generated at the process for detoxification of the toxic organic chlorinated compound is separated and recovered from the processed oil, the amount of the salt contained in the processed oil can be reduced to an extremely low level. Therefore, when the waste oil obtained by separating the valuable resource from the processed oil is incinerated, it becomes possible to effectively intercept the generation of a toxic substance such as dioxin or the like.

What is claimed is:

1. A system for detoxification of a toxic organic chlorinated compound, the system comprising:
a detoxification process unit for decomposing said toxic organic chlorinated compound into a harmless organic compound by adding an additive including hydrogen donor, alkaline substance and precious metal catalyst to the toxic organic chlorinated compound stored in a container or included in a device, thereby to obtain harmless products;
a reproducing process unit for regenerating said products obtained by said detoxification process unit thereby to provide regenerated products; and
a recycle line for supplying the products obtained from the detoxification process unit to said reproducing process unit, and for supplying the regenerated products to said detoxification process unit so that the regenerated products are reused as a material for decomposing the toxic organic chlorinated compound.

2. A system for detoxification of a toxic organic chlorinated compound according to claim 1, wherein said reproducing process unit comprises a distillation unit for distilling a processed oil, which is obtained by the detoxification process at the detoxification process unit, thereby to recover a non-reacted hydrogen donor; and
wherein said recycle line supplies the recovered non-reacted hydrogen donor to said detoxification process unit so that the recovered non-reacted hydrogen donor is reused as a material for decomposing the toxic organic chlorinated compound.

3. A system for detoxification of a toxic organic chlorinated compound according to claim 1, wherein said reproducing process unit comprises an alkaline substance manufacturing unit, to which a saturated salt solution containing salt generated at the detoxification process unit is supplied, for regenerating the salt into alkaline substance, and
wherein said recycle line supplies the regenerated alkaline substance to said detoxification process unit so that the regenerated alkaline substance is reused as a material for decomposing the toxic organic chlorinated compound.

4. A system for detoxification of a toxic organic chlorinated compound according to claim 1, wherein said reproducing process unit comprises a regeneration unit, to which said precious metal catalyst used at the detoxification process unit is supplied, for sintering and regenerating the used precious metal catalyst, thereby to produce a regenerated precious metal catalyst; and
wherein said recycle line supplies the regenerated precious metal catalyst to said detoxification process unit.

5. A system for detoxification of a toxic organic chlorinated compound according to claim 1, wherein said reproducing process unit comprises: a distillation unit for distilling a processed oil which is obtained by the detoxification process at the detoxification process unit, thereby to recover a non-reacted hydrogen donor; and an alkaline substance manufacturing unit, to which a saturated salt solution containing salt generated at the detoxification process unit is supplied, for regenerating the salt as the alkaline salt,
wherein said recycle line supplies the recovered non-reacted hydrogen donor and the regenerated alkaline substance to said detoxification process unit, respectively.

6. A system for detoxification of a toxic organic chlorinated compound according to claim 1, wherein said reproducing process unit comprises: a distillation unit for distilling a processed oil which is obtained by the detoxification process at the detoxification process unit thereby to recover a non-reacted hydrogen donor; and a regeneration unit, to which said precious metal catalyst used at the detoxification process unit is supplied, for sintering and regenerating the used precious metal catalyst thereby to produce a regenerated precious metal catalyst;
wherein said recycle line supplies the recovered non-reacted hydrogen donor and the regenerated precious metal catalyst to said detoxification process unit, respectively.

7. A system for detoxification of a toxic organic chlorinated compound according to claim 1, wherein said reproducing process unit comprises: an alkaline substance manufacturing unit, to which a saturated salt solution containing salt generated at the detoxification process unit is supplied, for regenerating the salt into the alkaline salt; and a regeneration unit, to which said precious metal catalyst used at the detoxification process unit is supplied, for sintering and regenerating the used precious metal catalyst, thereby to produce a regenerated precious metal catalyst;
wherein said recycle line supplies the regenerated alkaline substance and the regenerated precious metal catalyst to said detoxification process unit, respectively.

8. A system for detoxification of a toxic organic chlorinated compound according to claim 1, wherein said reproducing process unit comprises:
a distillation unit for distilling a processed oil which is obtained by the detoxification process at the detoxification process unit, thereby to recover a non-reacted hydrogen donor;
an alkaline substance manufacturing unit, to which a saturated salt solution containing salt generated at the detoxification process unit is supplied, for regenerating the salt into the alkaline salt; and
a regeneration unit, to which said precious metal catalyst used at the detoxification process unit is supplied, for sintering and regenerating the used precious metal catalyst, thereby to produce a regenerated precious metal catalyst;
wherein said recycle line supplies the recovered non-reacted hydrogen donor, the regenerated alkaline substance and the regenerated precious metal catalyst to said detoxification process unit, respectively.

9. A system for detoxification of a toxic organic chlorinated compound according to any one of claims 1 to 8, wherein said detoxification process unit further comprises:
a take-out unit for boring a hole to a device and taking out the toxic organic chlorinated compound contained in said device through said hole;
a first shredding unit for shredding an insulation substance and metal member contained in the device;
a first scrub unit for scrubbing the crushed insulation substance and the metal member;
a melting unit for melting the scrubbed metal member to provide a metal raw material which is to be reused;
a second shredding unit for shredding at least one organic substance selected from the group consisting of waste cloth, plastic bag, paper and timber used in a decomposing process of the toxic organic chlorinated compound; and
a second scrub unit for scrubbing the crushed organic substance to provide a scrubbed organic substance,
wherein said recycle line supplies the scrubbed organic substance to said reproducing process unit and the reproducing process unit performs a reduction process to the scrubbed organic substance thereby to produce a reducer to be reused.

10. A system for detoxification of a toxic organic chlorinated compound, the system comprising:
a detoxification process unit for decomposing said toxic organic chlorinated compound into a harmless organic compound by adding an additive including hydrogen donor, alkaline substance and precious metal catalyst to the toxic organic chlorinated compound stored in a container or included in a device, thereby to obtain a harmless products;
a distillation unit, which is installed in said detoxification process unit, for distilling a processed oil obtained by the detoxification process at the detoxification process unit, thereby to recover a hydrogen donor; and
a recycle line for supplying said hydrogen donor to the detoxification process unit so that the hydrogen donor is reused in the detoxification process for the toxic organic chlorinated compound, and for supplying the processed oil, from which the hydrogen donor is removed or a fractionally separated oil, to an user so that the oil is reused as a material for chemical industrial products.

11. A system for detoxification of a toxic organic chlorinated compound, the system comprising:
a detoxification process unit for decomposing said toxic organic chlorinated compound into a harmless organic compound by adding an additive including hydrogen donor, alkaline substance and precious metal catalyst to the toxic organic chlorinated compound stored in a container or included in a device, thereby to obtain harmless products;
a distillation unit, which is installed in said detoxification process unit, for distilling a processed oil obtained by the detoxification process at the detoxification process unit, thereby to recover a hydrogen donor;
an incineration unit for incinerating the processed oil from which the hydrogen donor is removed, thereby to generate exhaust heat; and
a recycle line for supplying said hydrogen donor separated and recovered at the distillation unit to the detoxification process unit so that the hydrogen donor is reused in the detoxification process for the toxic organic chlorinated compound, and for supplying the exhaust heat generated at the incineration unit to an user.

12. A system for detoxification of a toxic organic chlorinated compound according to claim 10 or 11, wherein said reproducing process unit further comprises: an alkaline substance manufacturing unit, to which a saturated salt solution containing salt generated at the detoxification process unit is supplied, for regenerating the salt into the alkaline substance,
wherein said recycle line supplies the regenerated alkaline substance to said detoxification process unit.

13. A system for detoxification of a toxic organic chlorinated compound according to any one of claims 10 to 12, wherein said detoxification process unit further comprises:
a take-out unit for boring a hole to a waste device and for taking out the toxic organic chlorinated compound contained in the waste device through the hole;
a first shredding unit for shredding an insulating material and a metal member contained in the waste device;
a first scrubbing unit for scrubbing the crushed insulating material and the metal member;
a melting unit for melting the scrubbed metal member to provide a metal raw material which is to be reused;
a second shredding unit for shredding at least one organic substance selected from the group consisting of waste cloth, plastic bag, paper and timber used in a decomposing process of the toxic organic chlorinated compound; and
a second scrub unit for scrubbing the crushed organic substance to provide a scrubbed organic substance,
wherein said recycle line supplies the scrubbed organic substance to said reproducing process unit and the reproducing process unit performs a reduction process to the scrubbed organic substance thereby to produce a reducer which is reused through said recycle line.

14. A system for detoxification of a toxic organic chlorinated compound according to claim 1, wherein said detoxification process unit comprises a plurality of detoxification process elements installed at different sites, and said reproducing process unit comprises a plurality of reproducing process elements for reproducing products processed by each detoxification process elements, the number of installed said reproducing process elements being less than the number of installed said detoxification process elements,
wherein said products reproduced by the plurality of the detoxification process elements are concentrately supplied to said reproducing process elements so that the reproducing process elements process the products thereby to provide processed products, and
wherein said recycle line supplies the processed products obtained from the reproducing process elements to said detoxification process elements so that the processed products are reused as a material for decomposing the toxic organic chlorinated compound.

15. A system for detoxification of a toxic organic chlorinated compound according to claim 14, wherein said detoxification process unit comprises a plurality of detoxification process elements installed at different sites, and said reproducing process unit comprises a plurality of distillation elements for distilling a processed oil, which is obtained by the detoxification process at the detoxification process elements, thereby to recover a non-reacted hydrogen donor; the number of installed said distillation elements being less than the number of installed said detoxification process elements, and
wherein said processed oil obtained by the detoxification process at the detoxification process elements is concentrately supplied to the distillation elements, and said recycle line supplies the recovered non-reacted hydrogen donor to said detoxification process elements so that the recovered non-reacted hydrogen donor is reused as a material for decomposing the toxic organic chlorinated compound.

16. A system for detoxification of a toxic organic chlorinated compound according to any one of claims 10, 11 and 14, wherein said detoxification process unit comprises a plurality of detoxification process elements installed at different sites, and said reproducing process unit comprises a plurality of alkaline substance manufacturing elements, to which a saturated salt solution containing salt generated at the detoxification process elements is supplied, for regenerating the salt into the alkaline substance, the number of installed said alkaline substance manufacturing elements being less than the number of installed said detoxification process elements and
wherein said saturated salt solution containing salt generated at the detoxification process elements is concentrately supplied to the alkaline substance manufacturing elements, and said recycle line supplies the regenerated alkaline substance to said detoxification process elements so that the regenerated alkaline substance is reused as a material for decomposing the toxic organic chlorinated compound.

17. A system for detoxification of a toxic organic chlorinated compound according to any one of claims 10, 11 and 14, wherein said detoxification process unit comprises a plurality of detoxification process elements installed at different sites, and said reproducing process unit comprises a plurality of regeneration elements, to which precious metal catalyst used at the detoxification process elements is supplied, for sintering and regenerating the used precious metal catalyst, thereby to produce a regenerated precious metal catalyst, the number of installed said regeneration elements being less than the number of installed said detoxification process elements and
wherein said used precious metal catalyst used at the detoxification process elements is concentrately supplied to said regeneration elements, and said recycle line supplies the regenerated precious metal catalyst to said detoxification process elements.

18. A system for detoxification of a toxic organic chlorinated compound according to claim 15, wherein said reproducing process unit further comprises a plurality of alkaline substance manufacturing elements, to which a saturated salt solution containing salt generated at the detoxification process elements is supplied, for regenerating the salt into the alkaline substance, the number of installed said alkaline substance manufacturing elements being less than the number of installed said detoxification process elements, and
wherein said saturated salt solution containing salt generated at the detoxification process elements is concentrately supplied to the alkaline substance manufacturing elements, and said recycle line supplies the regenerated alkaline substance to said detoxification process elements so that the regenerated alkaline substance is reused as a material for decomposing the toxic organic chlorinated compound.

19. A system for detoxification of a toxic organic chlorinated compound according to claim 15, wherein said reproducing process unit further comprises a plurality of regeneration elements, to which precious metal catalyst used at the detoxification process elements is supplied, for sintering and regenerating the used precious metal catalyst, thereby to produce a regenerated precious metal catalyst, the number of installed said regeneration elements being less than the number of installed said detoxification process elements, and
wherein said used precious metal catalyst used at the detoxification process elements is concentrately supplied to said regeneration elements, and said recycle line supplies the regenerated precious metal catalyst to said detoxification process elements.

20. A system for detoxification of a toxic organic chlorinated compound according to claim 19, wherein said reproducing process unit further comprises a plurality of alkaline substance manufacturing elements, to which a saturated salt solution containing salt generated at the detoxification process elements is supplied, for regenerating the salt into the alkaline substance, the number of installed said alkaline substance manufacturing elements being less than the number of installed said detoxification process elements, and
wherein said saturated salt solution containing salt generated at the detoxification process elements is concentrately supplied to the alkaline substance manufacturing elements, and said recycle line supplies the regenerated alkaline substance to said detoxification process elements so that the regenerated alkaline substance is reused as a material for decomposing the toxic organic chlorinated compound.

21. A system for detoxification of a toxic organic chlorinated compound according to claim 16, wherein said reproducing process unit further comprises a plurality of regeneration elements, to which precious metal catalyst used at the detoxification process elements is supplied, for sintering and regenerating the used precious metal catalyst, thereby to produce a regenerated precious metal catalyst, the number of installed said regeneration elements being less than the number of installed said detoxification process elements, and
wherein said used precious metal catalyst used at the detoxification process elements is concentrately supplied to said regeneration elements, and said recycle line supplies the regenerated precious metal catalyst to said detoxification process elements.

22. A method of recycling a detoxified waste comprising the steps of:
adding an additive including hydrogen donor, alkaline substance and precious metal catalyst to a toxic organic chlorinated compound;
decomposing said toxic organic chlorinated compound into a harmless organic compound thereby to provide harmless products; and
recycling the products by utilizing at least one processing method selected from the group consisting of:
(1) a processing method in which a non-reacted hydrogen donor is recovered from a processed oil as the products obtained from the decomposing process, and the non-reacted hydrogen donor is reused as a material for decomposing the toxic organic chlorinated compound;
(2) a processing method in which a waste oil produced by removing hydrogen donor from the processed oil obtained from the decomposing process is reused as a material of chemical industrial products; or the waste oil or an oil produced by removing valuable resource from the waste oil is incinerated and the exhausted heat is utilized as a heat resource;
(3) a processing method in which a precious metal catalyst used at the decomposing process is regenerated and the regenerated precious metal catalyst is reused as a material for decomposing the toxic organic chlorinated compound; and
(4) a processing method in which a salt obtained from the decomposing process is regenerated into an alkaline substance and the regenerated alkaline substance is reused as a material for decomposing the toxic organic chlorinated compound.

23. A method of recycling a detoxified waste, comprising the steps of:
adding an additive including hydrogen donor, alkaline substance and precious metal catalyst to a toxic organic chlorinated compound stored in a container or included in a waste device;
decomposing the toxic organic chlorinated compound into a harmless organic compound;
detoxifying at least one organic substance selected from the group consisting of waste cloth, plastic bag, paper and timber used in said decomposing process of the toxic organic chlorinated compound;
applying a reduction process to the detoxified organic substance thereby to produce a reducer, and utilizing the reducer;
detoxifying a metal member generated at a time of scrapping the container or the waste device, and melting and regenerating the detoxified metal member, thereby to utilize the regenerated metal member as a raw metal material.
